(19) United States
(12) Patent Application Publication
(10) Pub. No.: US 2024/0069553 A1
(43) Pub. Date: Feb. 29, 2024

(54) MOBILE BODY CONTROL SYSTEM, MOBILE BODY, AND MOBILE BODY CONTROL METHOD

(71) Applicant: NEC Corporation, Minato-ku, Tokyo (JP)

(72) Inventor: Taichi Kumagai, Tokyo (JP)

(73) Assignee: NEC Corporation, Minato-ku, Tokyo (JP)

(21) Appl. No.: 18/268,541

(22) PCT Filed: Mar. 25, 2021
(86) PCT No.: PCT/JP2021/012514

§ 371 Date: Jun. 20, 2023

(51) Int. Cl. G05D 1/02

(52) U.S. Cl. CPC G05D 1/0214

(57) ABSTRACT

A mobile body control system (1A) according to the present disclosure includes a mobile body (10), and a control unit (20) configured to control the mobile body (10), a receiving unit (30) configured to receive control information from the control unit (20), and a path specifying unit (40) configured to specify a path of the mobile body (10) based on the control information. The path specifying unit (40) corrects, according to a distance between the mobile body (10) and an obstacle, the path of the mobile body (10) to such a path that the mobile body (10) evades a hazardous area including an area around the obstacle.

### TECHNICAL FIELD

The present disclosure relates to a mobile body control system, a mobile body, and a mobile body control method.

### BACKGROUND ART

In recent years, a mobile body the control of which can be switched between manually-operated control and autonomous control has been developed. When it is predicted that such a mobile body will collide with an obstacle while it is moving under a manual operation, the mobile body is autonomously controlled so as to evade the obstacle.

For example, in Patent Literature 1, it is stated that when it is determined that an indicated path according to an operating command from an operator is not safe, a corrected path obtained by correcting the indicated path is generated and the mobile body travels according to the corrected path.

### CITATION LIST

### Patent Literature

Patent Literature 1: Japanese Unexamined Patent Application Publication No. 2020-112977

### SUMMARY OF INVENTION

### Technical Problem

It should be noted that, in general, a decision criterion used to determine whether a path of a mobile body is safe or not is set with a margin.

In Patent Literature 1, it is stated that a distance between the path of the mobile body and an obstacle is used as the above-described decision criterion. However, when the above-described distance used as the decision criterion is set with a margin, the mobile body cannot be controlled in a flexible manner. For example, the distance between the mobile body and an obstacle (e.g., a wall, a pillar, or the like) becomes short in a narrow passage as a matter of course, so that, in the first place, it is impossible to set the above-described distance used as the decision criterion with a margin. As a result, it becomes difficult to make the mobile body travel on a narrow passage.

Further, when the above-described distance used as the decision criterion is set so that the path can be very close to an obstacle, in this case also the mobile body cannot be controlled in a flexible manner. For example, when the above-described distance used as the decision criterion is set very close to an obstacle, the mobile body may collide with the obstacle if an error occurs in the control of the mobile body.

Therefore, an object of the present disclosure is to solve the above-described problem and thereby to provide a mobile body control system, a mobile body, and a mobile body control method capable of controlling a mobile body in a flexible manner.

### Solution to Problem

A mobile body control system according to an aspect includes:

a mobile body; and

a control unit configured to control the mobile body, in which

the mobile body includes:

a receiving unit configured to receive control information from the control unit; and

a path specifying unit configured to specify a path of the mobile body based on the control information, and

the path specifying unit corrects, according to a distance between the mobile body and an obstacle, the path of the mobile body to such a path that the mobile body evades a hazardous area including an area around the obstacle.

A mobile body according to an aspect includes:

a receiving unit configured to receive control information from a control unit; and

a path specifying unit configured to specify a path of the mobile body based on the control information, in which

the path specifying unit corrects, according to a distance between the mobile body and an obstacle, the path of the mobile body to such a path that the mobile body evades a hazardous area including an area around the obstacle.

A method for controlling a mobile body according to an aspect includes:

a receiving step of receiving control information from a control unit; and

a path specifying step of specifying a path of the mobile body based on the control information, in which

in the path specifying step, the path of the mobile body is corrected, according to a distance between the mobile body and an obstacle, to such a path that the mobile body evades a hazardous area including an area around the obstacle corrects.

### Advantageous Effects of Invention

According to the above-described aspect, it is possible to obtain an advantageous effect that a mobile body control system, a mobile body, and a mobile body control method capable of controlling a mobile body in a flexible manner can be provided.

### BRIEF DESCRIPTION OF DRAWINGS

FIG. 1 shows an example of a configuration of a mobile body control system according to a first example embodiment;

FIG. 2 shows an example of a configuration of a mobile body according to the first example embodiment;

FIG. 3 is a diagram for explaining an example of operations performed by a path specifying unit according to the first example embodiment;

FIG. 4 shows an example of a modified configuration of a mobile body control system according to the first example embodiment;

FIG. 5 is a flowchart showing an example of a general operation flow of the mobile body control system according to the first example embodiment;

FIG. 6 shows an example of a configuration of a mobile body control system according to a second example embodiment;

FIG. 7 is a sequence diagram showing an example of a general operation flow of the mobile body control system according to the second example embodiment;

FIG. 8 shows an example of a table held by a path specifying unit according to another example embodiment;

FIG. 9 shows an example of a table held by a path specifying unit according to another example embodiment;

FIG. 10 shows an example of a table held by a path specifying unit according to another example embodiment; and

FIG. 11 is a block diagram showing an example of a hardware configuration of a computer that implements a part of a mobile body according to the first or second example embodiment.

### EXAMPLE EMBODIMENT

An example embodiment according to the present disclosure will be described hereinafter with reference to the drawings. Note that the following description and the drawings are partially omitted and simplified as appropriate for clarifying the explanation. Further, the same reference numerals (or symbols) are assigned to the same components/structures throughout the drawings, and redundant descriptions thereof are omitted as appropriate. Further, specific numerical values and the like shown below are shown just for an illustrative purpose in order to facilitate the understanding of the present disclosure, and they are not limited to the below-shown numerical values and the like.

### First Example Embodiment

Firstly, an example of a configuration of a mobile body control system 1 according to a first example embodiment will be described with reference to FIG. 1. As shown in FIG. 1, the mobile body control system 1 according to the first example embodiment includes a mobile body 10 and a control unit 20. Note that in FIG. 1, the mobile body 10 is shown in a plan view as viewed from above.

The mobile body 10 has such a configuration that the control of the mobile body 10 can be switched between control by the control unit 20 and autonomous control, and is implemented, for example, as a robot, a transport vehicle for conveying objects, or the like.

Further, the mobile body 10 includes a pair of left and right driving wheels 11L and 11R, and can perform a movement in a straight line, a turning movement, and the like. The two driving wheels 11L and 11R can be driven independently of each other. Note that the movement in a straight line may include at least a forward movement in a straight line, and whether or not it can also move backward in a straight line may be determined as desired.

The control unit 20 controls the mobile body 10. For example, the control unit 20 may control the mobile body 10 from a remote place. Further, the control unit 20 may be manually operated, or operated by a robot or other types of apparatuses.

Further, the control unit 20 specifies, in response to an input, control information, which is information for controlling the mobile body 10, and transmits the specified control information to the mobile body 10. Specifically, the control information is information indicating a movement (a movement in a straight line, a turning movement, and the like), a speed, and the like of the mobile body 10. When the entity that controls the mobile body 10 is a person, the control unit 20 may generate the control information from an operation input by the person. The operation input is, for example, an input by an operation of a handle (e.g., a steering wheel), a lever (e.g., a joy stick), or a wireless communication device (a tablet-type computer or a smartphone). Further, when the entity that controls the mobile body 10 is a robot or other types of apparatuses, the control unit 20 may generate the control information from an input from the robot or other types of apparatuses. Further, the robot or other types of apparatuses may generate the control information.

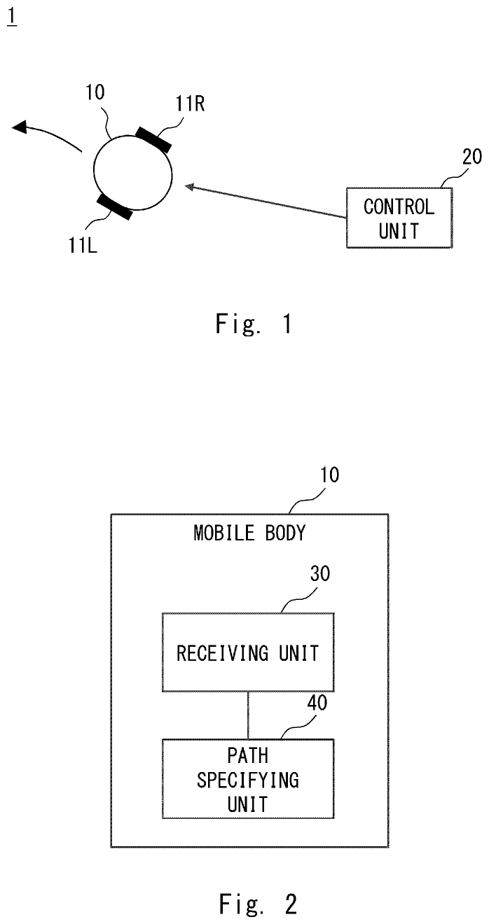

Next, an example of a configuration of the mobile body 10 according to the first example embodiment will be described with reference to FIG. 2. As shown in FIG. 2, the mobile body 10 according to the first example embodiment includes a receiving unit 30 and a path specifying unit 40. Note that in FIG. 2, components such as the driving unit that drives the driving wheels 11L and 11R are omitted.

The receiving unit 30 receives control information from the control unit 20.

The path specifying unit 40 specifies a path of the mobile body 10 based on the control information received from the control unit 20. Then, the path specifying unit 40 corrects, according to the distance between the mobile body 10 and an obstacle, the path of the mobile body 10 to such a path that the mobile body 10 evades a hazardous area. The obstacle is, for example, a shelf, a wall, other mobile bodies 10, an object, a desk, a work machine, a person, or the like. Note that the hazardous area is an area including an area around the obstacle. The hazardous area is set to define a distance that is set to prevent the collision between the mobile body 10 and an obstacle, and is a predetermined distance from the obstacle. When the mobile body 10 enters the hazardous area, the risk that the mobile body 10 will collide with the obstacle increases.

For example, the path specifying unit 40 generates a control signal for controlling the driving unit, which drives the driving wheels 11L and 11R, based on the control information received from the control unit 20. When the path specifying unit 40 corrects the path based on the control information received from the control unit 20, it calculates an offset value for correcting the control signal so that the mobile body 10 travels in a direction for evading the hazardous area and corrects the control signal based on the calculated offset value.

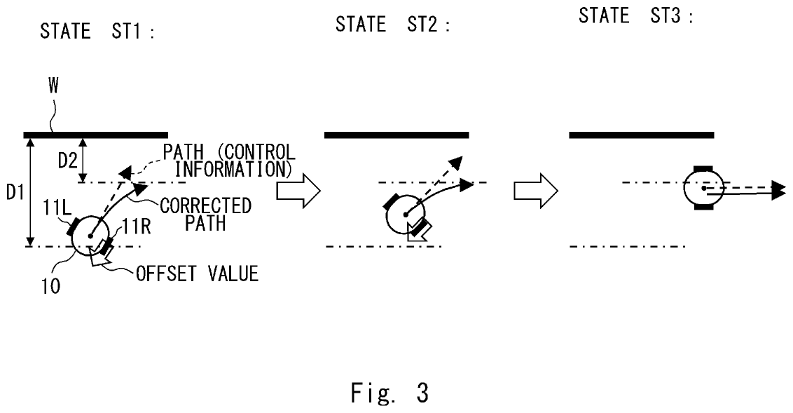

Operation performed by the path specifying unit 40 will be described hereinafter in detail with reference to FIG. 3. Note that FIG. 3 shows an example where the obstacle is a wall W.

As shown in FIG. 3, a first distance D1 and a second distance D2 are defined as distances between the mobile body 10 and the wall W. Note that in the example shown in FIG. 3, the distance between the mobile body 10 and the wall W is a distance between the center of the mobile body 10 and the wall W.

The second distance D2 is a distance for defining a hazardous area. An area from the obstacle to the second distance D2 becomes the hazardous area.

The first distance D1 is a distance at which the mobile body 10 starts to correct its path in order to evade the hazardous area. Further, the first distance D1 is a distance obtained by adding a predetermined margin to the second distance D2. By setting the first distance D1 to a small value, it is possible to control the mobile body 10 in such a manner that its path is not corrected until the mobile body 10 moves very close to the hazardous area. On the other hand, by setting the first distance D1 to a large value, it is possible to correct the path so that the mobile body 10 gradually evades the hazardous area.

The path specifying unit 40 generates, based on the control information received from the control unit 20, a control signal for controlling the driving unit and thereby controls the travelling of the mobile body 10. Further, when the path specifying unit 40 is controlling the travelling of the mobile body 10, it monitors the distance between the mobile body 10 and the wall W.

Here, assume that, in a state ST1, the distance between the mobile body 10 and the wall W becomes shorter than the first distance D1. In this case, the path specifying unit 40 corrects the path, which was set based on the control information received from the control unit 20, so that the mobile body 10 evades the hazardous area including the wall W (i.e., the area from the wall W to the second distance D2).

In the example shown in FIG. 3, the path based on the control information received from the control unit 20 is such a path that the mobile body 10 performs a movement in a straight line and thereby moves forward in a straight line. Therefore, the path specifying unit 40 corrects the path to such a path that the mobile body 10 turns to the right in order to evade the hazardous area. In particular, the path specifying unit 40 calculates such an offset value that the mobile body 10 will turn to the right, and corrects the control signal based on the calculated offset value. For example, the path specifying unit 40 may correct the control signal based on the offset value so that the mobile body 10 performs the turning movement in a stepwise manner over a plurality of steps. In other words, the path specifying unit 40 may correct the control signal so that the mobile body has a curved traveling trajectory. Alternatively, the path specifying unit 40 may correct the control signal so that the mobile body 10 evades the hazardous area by one turning movement.

The offset value in this process is, for example, such an offset value that the rotation speed of the driving wheel 11R on the right side is reduced. Alternatively, an arc movement or the like is assumed, and the offset value may be calculated so that the trajectory of the traveling of the mobile body 10 draws a curve that asymptotically approaches the second distance D2. Alternatively, the offset value may be calculated so that, while fixing the speed of the center of gravity of the mobile body 10, it increases as the mobile body 10 approaches the second distance D2, so that the mobile body 10 performs a turning motion upon reaching the second distance D2.

As a result, through a state ST2, in a state ST3, the trajectory of the traveling of the mobile body 10 becomes a trajectory roughly parallel to the wall W, so that the hazardous area is evaded. Therefore, the path specifying unit 40 returns the control signal to one that is determined based on the control information received from the control unit 20.

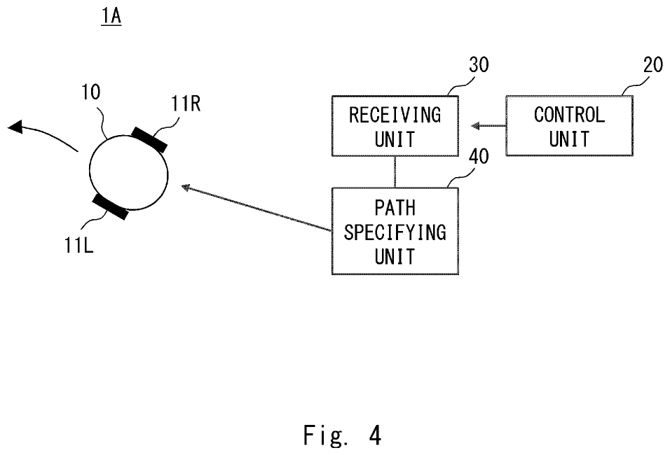

Note that the receiving unit 30 and the path specifying unit 40 do not necessarily have to be provided inside the mobile body 10. Like the mobile body control system 1A shown in FIG. 4, the receiving unit 30 and the path specifying unit 40 may be provided outside the mobile body 10. Further, the receiving unit and the path specifying unit 40 do not necessarily have to be provided inside the same apparatus, but may be provided, for example, independently of each other in a cloud system.

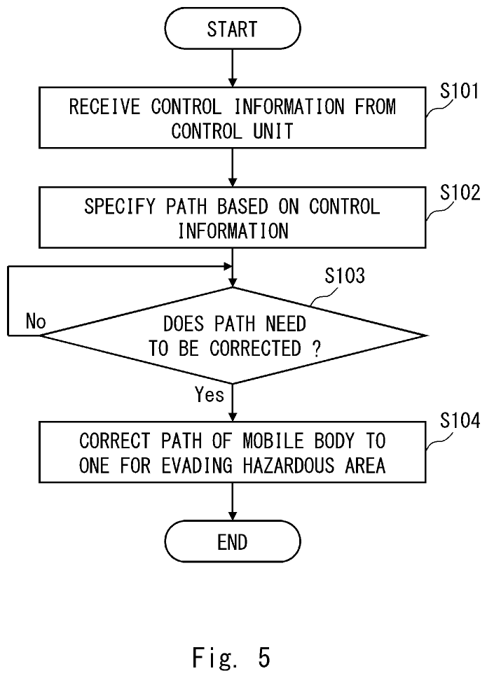

Next, an example of a general operation flow of the mobile body control system 1 according to the first example embodiment will be described with reference to FIG. 5.

As shown in FIG. 5, firstly, the receiving unit 30 receives control information from the control unit 20 (Step S101), and the path specifying unit 40 specifies a path of the mobile body 10 (Step S102). After that, based on the control information received from the control unit 20, the path specifying unit 40 generates a control signal for controlling the driving unit, which drives the driving wheels 11L and 11R, and thereby controls the travelling of the mobile body 10. Further, the path specifying unit 40 monitors the distance between the mobile body 10 and an obstacle (e.g., the wall W in FIG. 2).

Next, the path specifying unit 40 determines whether or not the path of the mobile body 10 needs to be corrected according to the distance between the mobile body 10 and the obstacle (Step S103). For example, when the distance between the mobile body 10 and the obstacle becomes shorter than the first distance D1, the path specifying unit 40 determines that the path of the mobile body 10 needs to be corrected. In the step S103, when it is determined that the path of the mobile body 10 does not need to be corrected (No in Step S103), the process returns to the step S103.

On the other hand, when it is determined, in the step S103, that the path of the mobile body 10 needs to be corrected (Yes in Step S103), the path specifying unit 40 corrects the path of the mobile body 10 to such a path that the mobile body 10 evades a hazardous area including an area around the obstacle (Step S104).

As described above, according to the first example embodiment, the path specifying unit 40 specifies the path of the mobile body 10 based on control information received from the control unit 20, and after that, corrects the path of the mobile body 10, according to the distance between the mobile body 10 and the obstacle, to such a path that the mobile body 10 evades a hazardous area including an area around an obstacle. In this way, it is possible to control the mobile body 10 in a flexible manner.

Note that the path specifying unit 40 may correct the path of the mobile body 10 when the distance between the mobile body 10 and the obstacle becomes shorter than the first distance D1.

By defining a hazardous area including an area around an obstacle (an area from the obstacle to the second distance D2) and a distance at which the mobile body 10 starts autonomous control so that the mobile body 10 evades the hazardous area (i.e., the first distance DO, it is possible to control the mobile body 10 in a more flexible manner.

Specifically, the mobile body 10 can be controlled under the control of the control unit 20 until the mobile body 10 exceeds the first distance D1 (i.e., until the distance between the mobile body 10 and the obstacle becomes shorter than the first distance D1).

Further, by gradually correcting the path after the mobile body 10 exceeds the first distance D1, it is possible to control the mobile body 10 so as to evade the hazardous area even when an error occurs in the control of the mobile body 10. As a result, the mobile body 10 can evade the hazardous area.

Further, the fact that the mobile body 10 can be controlled so as to evade the hazardous area means that, when it is expressed in another way, the mobile body 10 is allowed to move close to the hazardous area. Therefore, it is also possible to make the mobile body 10 travel on a narrow passage.

Further, after the mobile body 10 exceeds the first distance D1, the mobile body 10 evades the hazardous area by the autonomous control, so that it is possible to prevent the mobile body 10 from reaching the hazardous area while waiting for an additional instruction from the control unit 20, and prevent the efficiency of the traveling of the mobile body 10 from decreasing.

### Second Example Embodiment

A second example embodiment is an example in which the configuration and operation of the mobile body 10 according to the first example embodiment are described in a more detailed manner.

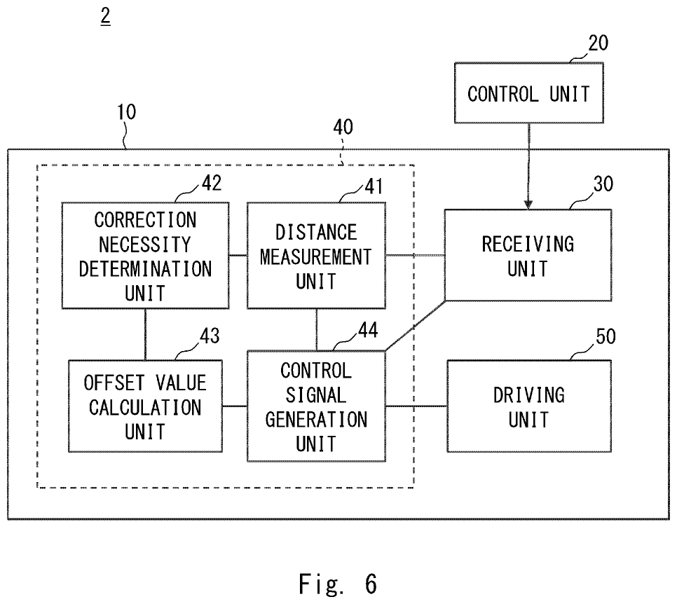

Firstly, an example of a configuration of a mobile body control systems 2 according to the second example embodiment will be described with reference to FIG. 6. As shown in FIG. 6, the overall configuration of the mobile body control systems 2 according to the second example embodiment is similar to that of the above-described mobile body control system 1 according to the first example embodiment, but the configuration of the mobile body 10 is different from that in the first example embodiment. That is, the mobile body 10 according to the second example embodiment includes a driving unit 50 in addition to the receiving unit 30 and the path specifying unit 40. Further, the path specifying unit 40 includes a distance measurement unit 41, a correction necessity determination unit 42, an offset value calculation unit 43, and a control signal generation unit 44. Components different from those in the above-described first example embodiment will be described hereinafter.

The distance measurement unit 41 is a range sensor that measures the distance between the mobile body 10 and an obstacle. Note that the distance measurement unit 41 may periodically measure the aforementioned distance, or may measure the distance upon receiving an instruction from the control unit 20. Further, the range sensor is not limited to any particular type, i.e., may be any type such as an optical, radio wave, or ultrasonic type. Further, the distance measurement unit 41 may be disposed outside the mobile body 10. In this case, the mobile body 10 may acquire information about the distance between the mobile body 10 and the obstacle from the distance measurement unit 41 disposed outside thereof.

The correction necessity determination unit 42 determines, based on the distance between the mobile body 10 and the obstacle measured by the distance measurement unit 41, whether or not the path of the mobile body 10 that is determined based on the control information received from the control unit 20 needs to be corrected. Specifically, when the distance between the mobile body and the obstacle becomes shorter than the first distance D1, the correction necessity determination unit 42 determines that the path needs to be corrected. However, the present disclosure is not limited to this example. For example, dependent on the current control information, in some cases, it is already known that the mobile body 10 will not reach the hazardous area. In such a case, the correction necessity determination unit 42 may determine that the path of the mobile body 10 does not need to be corrected.

When it is determined, by the correction necessity determination unit 42, that the path of the mobile body 10 needs to be corrected, the offset value calculation unit 43 calculates an offset value for correcting the control signal so that the mobile body 10 evades the hazardous area.

In general, the control signal generation unit 44 generates the control signal based on the control information received from the control unit 20. However, when it is determined, by the correction necessity determination unit 42, that the operation performed by the control unit 20 needs to be corrected, the control signal generation unit 44 corrects the control signal based on the offset value calculated by the offset value calculation unit 43. The control signal generated or corrected by the control signal generation unit 44 is output to the driving unit 50.

The driving unit 50 drives the driving wheels 11L and 11R independently of each other based on the control signal output from the control signal generation unit 44. In this way, since the rotation directions and rotation speeds of the driving wheels 11L and 11R can be controlled independently of each other, the mobile body 10 can perform a movement in a straight line, a turning movement, and the like.

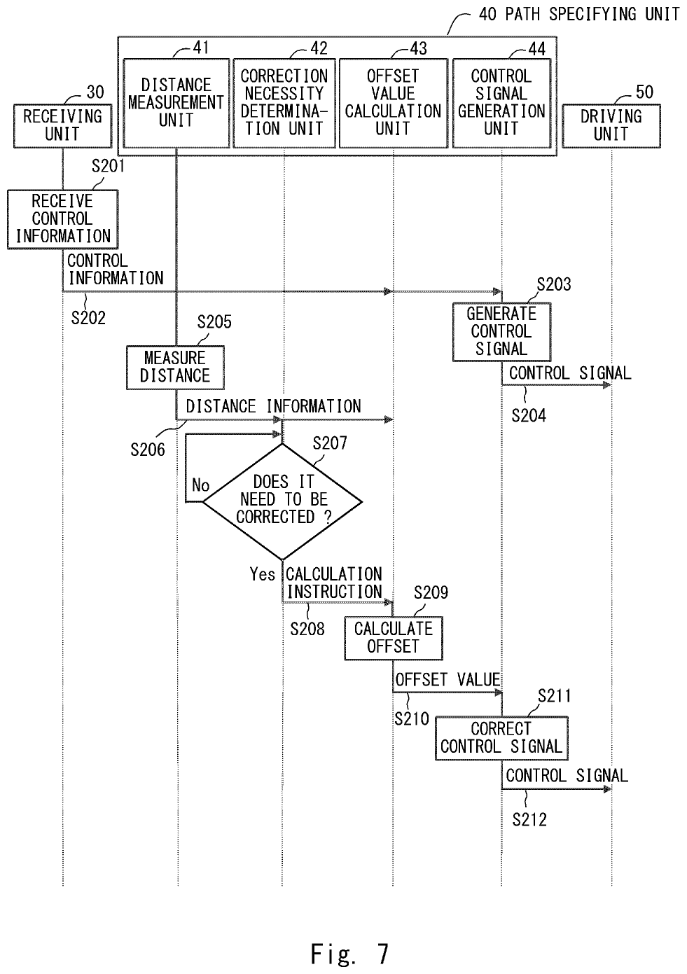

Next, an example of a general operation flow of the mobile body control systems 2 according to the second example embodiment will be described with reference to FIG. 7.

As shown in FIG. 7, firstly, the receiving unit 30 receives control information from the control unit 20 (Step S201) and outputs the received control information to the offset value calculation unit 43 and the control signal generation unit 44 (Step S202). The control signal generation unit 44 generates a control signal based on the control information (Step S203) and outputs the generated control signal to the driving unit 50 (Step S204). It is assumed that the steps S201 to S204 are repeatedly performed while the mobile body 10 is receiving the control information from the control unit 20.

Meanwhile, the distance measurement unit 41 measures the distance between the mobile body 10 and an obstacle (Step S205) and outputs distance information representing the measured distance to the correction necessity determination unit 42 and the offset value calculation unit 43 (Step S206).

The correction necessity determination unit 42 determines, based on the distance information, whether or not the path of the mobile body 10 that is generated based on the control information received from the control unit 20 needs to be corrected (Step S207). Specifically, when the distance between the mobile body 10 and the obstacle becomes shorter than the first distance D1, the correction necessity determination unit 42 determines that the path needs to be corrected. In the step S207, when it is determined that the path of the mobile body 10 does not need to be corrected (No in Step S207), the process returns to the step S207.

On the other hand, when it is determined, in the step S207, that the path needs to be corrected (Yes in Step S207), the correction necessity determination unit 42 outputs, to the offset value calculation unit 43, a calculation instruction for instructing the offset value calculation unit 43 to calculate an offset value for correcting the control signal (Step S208).

Next, the offset value calculation unit 43 calculates, based on the control information and the distance information, an offset value so that the mobile body evades the hazardous area (Step S209), and outputs the calculated offset value to the control signal generation unit 44 (Step S210).

After that, the control signal generation unit 44 corrects the control signal based on the offset value (Step S211) and outputs the corrected control signal to the driving unit 50 (Step S212).

As described above, according to the second example embodiment, the path specifying unit 40 generates a control signal for controlling the driving unit 50 based on the control information received from the control unit 20. In this state, when the distance between the mobile body 10 and the obstacle becomes shorter than the first distance D1, the path specifying unit 40 calculates an offset value so that the mobile body 10 evades a hazardous area including the obstacle, and corrects the control signal based on the calculated offset value.

As described above, according to the second example embodiment, similar to the above-described first example embodiment, the path specifying unit 40 corrects, according to the distance between the mobile body 10 and the obstacle, the path of the mobile body 10 to such a path that the mobile body 10 evades the hazardous area including an area around the obstacle. In this way, similarly to the above-described first example embodiment, it is possible to control the mobile body 10 in a flexible manner.

### Other Example Embodiment

In the above-described example embodiments, in addition to defining the first distance D1, a second distance D2 is also defined to define a hazardous area. It should be noted that the first and second distances D1 and D2 do not necessarily have to be fixed values.

For example, the higher the speed of the mobile body 10 is, the faster the mobile body 10 moves closer to the obstacle, and the more the risk that the mobile body 10 may collide with the obstacle increases.

Therefore, when the speed of the mobile body 10 indicated by the control information is high, the first and second distances D1 and D2 may be changed to larger values.

As described above, the first and second distances D1 and D2 may be changed according to the speed of the mobile body 10 indicated by the control information received from the control unit 20.

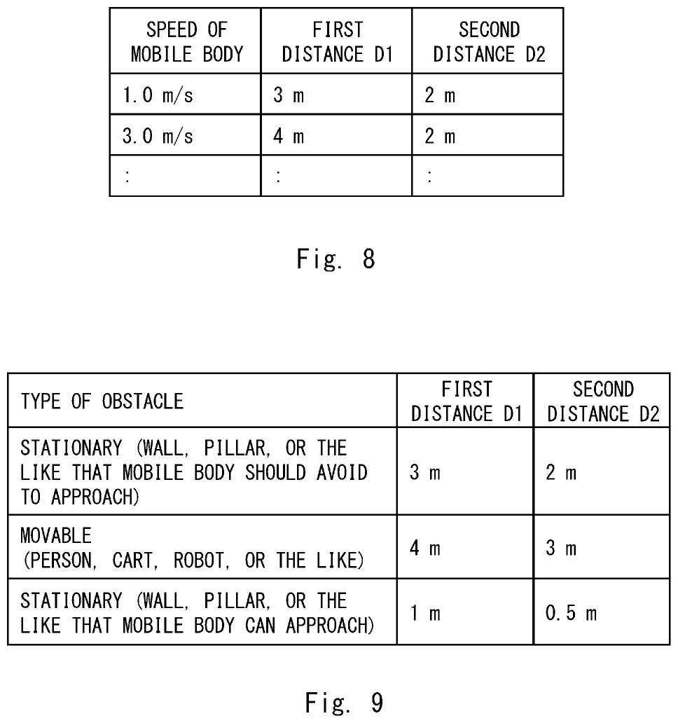

In order to carry out the above-described operation, the path specifying unit 40 may hold, for example, a table as shown in FIG. 8. In the table shown in FIG. 8, first and second distances D1 and D2 corresponding to speeds of the mobile body 10 indicated by the control information are set. In this case, the path specifying unit 40 may specify, by referring to the table shown in FIG. 8, the first and second distances D1 and D2 (i.e., the hazardous area) based on the speed of the mobile body 10 indicated by the control information.

Further, when the obstacle is a movable moving obstacle (e.g., a person, a transport vehicle, or a robot), the risk that the mobile body 10 may collide with the obstacle increases.

Therefore, when the obstacle is a movable obstacle, the first and second distances D1 and D2 may be changed to values larger than those set for a stationary obstacle.

Further, among stationary obstacles (e.g., walls, columns, and the like), there are those to which the mobile body 10 can move closer. For example, in the case where it is desired that the mobile body 10 be moved very close to a wall to save the space or the like, or when the destination of the mobile body 10 is a place just beside a wall, the wall is regarded as an obstacle to which mobile body can move closer.

Therefore, when the obstacle is a stationary obstacle to which the mobile body 10 can move closer, the first and second distances D1 and D2 may be changed to smaller values than those set for a movable obstacle.

As described above, the first and second distances D1 and D2 may be changed according to the type of obstacle.

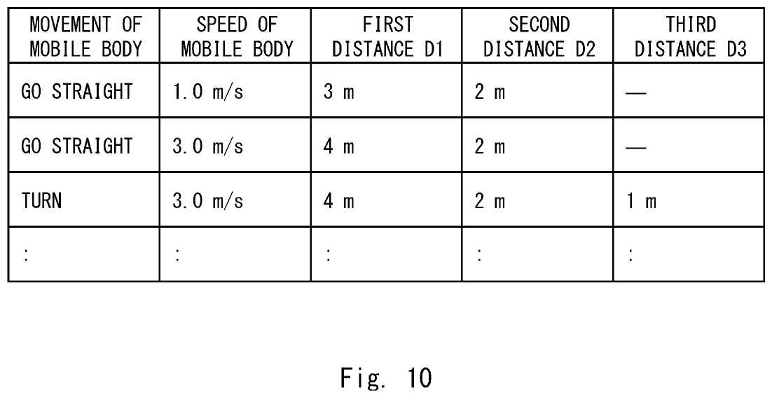

In order to carry out the above-described operation, the path specifying unit 40 may hold, for example, a table as shown in FIG. 9. In the table shown in FIG. 9, first and second distances D1 and D2 corresponding to types of obstacles are set. In this case, the path specifying unit 40 may specify, by referring to the table shown in FIG. 9, the first and second distances D1 and D2 (i.e., the hazardous area) based on the type of obstacle.

Note that how to classify obstacles according to the type thereof is not limited to the example shown in FIG. 9. For example, even in the case where the obstacle is a person, i.e., a movable obstacle, the risk of a collision changes depending on whether or not the person is facing the mobile body 10. Therefore, in the case where the obstacle is a person, the first and second distances D1 and D2 that are set when the person is not facing the mobile body 10 may be changed to larger values than the first and second distances D1 and D2 that are set when the person is facing the mobile body 10.

Further, there are cases where the mobile body 10 exceeds the second distance D2 (i.e., the distance between the mobile body 10 and the obstacle becomes shorter than the second distance D2) and moves closer to the obstacle due to an error in the control of the mobile body 10 or the movement of the movable obstacle. However, depending on the movement of the mobile body 10, in some cases, even when there is an obstacle near the mobile body 10, the risk that the mobile body 10 may collide with the obstacle may be low. For example, in the case of a turning movement, since it is a movement to change the traveling direction, it is unlikely that the mobile body 10 may move closer to the obstacle beyond the distance at that moment (i.e., it is unlikely that the mobile body 10 may move closer to the obstacle than the current position).

Therefore, the path specifying unit 40 may specify the hazardous area according to the movement of the mobile body indicated by the control information. A third distance D3 may be defined as a distance for defining a hazardous area when the mobile body 10 is performing a turning movement. When the mobile body 10 performs the turning movement, an area from the obstacle to the third distance D3 becomes the hazardous area. The third distance D3 is equal to or shorter than the second distance D2. Then, when the mobile body 10 is performing a turning movement and the distance between the mobile body 10 and the obstacle becomes shorter than the first distance D1, the path of the mobile body 10 may be corrected so that the distance between the mobile body and the obstacle becomes longer than the third distance D3.

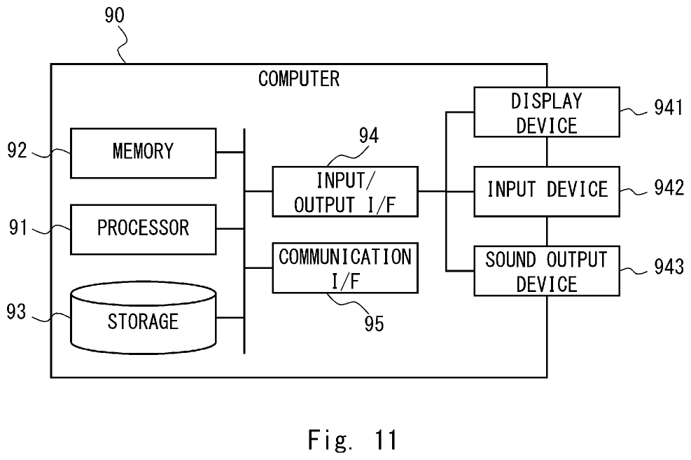

In order to carry out the above-described operation, the path specifying unit 40 may hold, for example, a table as shown in FIG. 10. In the table shown in FIG. 10, first and second distances D1 and D2 corresponding to movements and speeds of the mobile body 10 indicated by the control information generated or specified by the control unit 20 are set, and for the turning movement of the mobile body 10, third distances D3 corresponding to speeds of the mobile body 10 indicated by the control information may also be set. In this case, when the movement of the mobile body 10 indicated by the control information is a turning movement, the path specifying unit 40 may specify, by referring to the table shown in FIG. 10, the third distance D3 based on the speed of the mobile body 10 indicated by the control information. Then, when the movement of the mobile body 10 indicated by the control information is a turning movement and the distance between the mobile body 10 and the obstacle becomes shorter than the first distance D1, the path specifying unit 40 may correct the path of the mobile body 10 so that the distance between the mobile body 10 and the obstacle becomes longer than the third distance D3.

Note that there are cases where the mobile body 10 exceeds the third distance D3 (i.e., the distance between the mobile body 10 and the obstacle becomes shorter than the third distance D3) and moves closer to the obstacle. For example, a movable obstacle such as a person may approach the mobile body 10. In this case, the path specifying unit 40 may be brought into a standstill state, without allowing the mobile body 10 to perform even a turning movement, for the safety reason (so as not to make the person fearful of the mobile body 10 or the like).

<Hardware Configuration of Mobile Body According to Example Embodiment>

Next, an example of a hardware configuration of a computer 90 that implements a part of the mobile body 10 according to the above-described first example embodiment will be described with reference to FIG. 11.

As shown in FIG. 11, the computer 90 includes a processor 91, a memory 92, a storage 93, an input/output interface (input/output I/F) 94, a communication interface (communication I/F) 95, and the like. The processor 91, the memory 92, the storage 93, the input/output interface 94, and the communication interface 95 are connected to each other by data transmission lines for transmitting/receiving data to/from each other.

The processor 91 is, for example, an arithmetic processing unit such as a CPU (Central Processing Unit) or a GPU (Graphics Processing Unit). The memory 92 is, for example, a memory such as a RAM (Random Access Memory) or a ROM (Read Only Memory). The storage 93 is, for example, a storage device such as an HDD (Hard Disk Drive), an SSD (Solid State Drive), or a memory card. Further, the storage 93 may be a memory such as a RAM or a ROM.

The storage 93 stores programs for implementing the functions of the components included in the mobile body 10. The processor 91 implements the functions of the components included in the mobile body 10 by executing these programs. Note that the processor 91 may execute the aforementioned programs after loading them into the memory 92, or may execute them without loading them into the memory 92. Further, the memory 92 and the storage 93 also serve to store information and data held by the components included in the mobile body 10.

Further, the aforementioned programs may be stored in any of various types of non-transitory computer readable media and supplied to the computer (including the computer 90). The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a CD-ROM (Compact Disc-ROM), a CD-R (CD-Recordable), a CD-R/W (CD-ReWritable), and a semiconductor memory (such as a mask ROM, a PROM (Programmable ROM), an EPROM (Erasable PROM), a flash ROM, and a RAM). Further, the programs may be supplied to computers by using various types of transitory computer readable media. Examples of the transitory computer readable media include an electrical signal, an optical signal, and an electromagnetic wave. The transitory computer readable media can be used to supply programs to a computer through a wired communication line such as an electric wire and an optical fiber or a wireless communication line.

The input/output interface 94 is connected to a display device 941, an input device 942, a sound (or voice) output device 943, and the like. The display device 941 is a device, such as an LCD (Liquid Crystal Display), a CRT (Cathode Ray Tube) display, or a monitor, that displays a screen (i.e., an image such as a window) corresponding to drawing data processed by the processor 91. The input device 942 is a device that receives an operation input by an operator, such as a keyboard, a mouse, and a touch sensor, or the like. The display device 941 and the input device 942 may be integrated with each other and hence implemented as a touch panel. The sound output device 943 is a device, such as a speaker, that outputs a sound (or a voice) corresponding to acoustic data processed by the processor 91.

The communication interface 95 transmits/receives data to/from an external apparatus. For example, the communication interface 95 communicates with an external apparatus through a wired or wireless communication path.

Although the present disclosure is described above with reference to example embodiments, the present disclosure is not limited to the above-described example embodiments. Various modifications that can be understood by those skilled in the art can be made to the configuration and details of the present disclosure within the scope of the disclosure.

Further, the whole or part of the example embodiments disclosed above can be described as, but not limited to, the following supplementary notes.

(Supplementary Note 1)

A mobile body control system comprising:

a mobile body; and

a control unit configured to control the mobile body, wherein

the mobile body comprises:

a receiving unit configured to receive control information from the control unit; and

a path specifying unit configured to specify a path of the mobile body based on the control information, and

the path specifying unit corrects, according to a distance between the mobile body and an obstacle, the path of the mobile body to such a path that the mobile body evades a hazardous area including an area around the obstacle.

(Supplementary Note 2)

The mobile body control system described in Supplementary note 1, wherein the path specifying unit corrects the path of the mobile body when the distance between the mobile body and the obstacle becomes shorter than a first distance for the mobile body to evade the hazardous area.

(Supplementary Note 3)

The mobile body control system described in Supplementary note 2, wherein the path specifying unit specifies the first distance and the hazardous area according to a type of the obstacle.

(Supplementary Note 4)

The mobile body control system described in Supplementary note 2, wherein the path specifying unit specifies the first distance and the hazardous area according to a speed of the mobile body indicated by the control information.

(Supplementary Note 5)

The mobile body control system described in Supplementary note 1 or 2, wherein the path specifying unit specifies the hazardous area according to a movement of the mobile body indicated by the control information.

(Supplementary Note 6)

The mobile body control system described in any one of Supplementary notes 2 to 5, wherein the mobile body comprises:

a driving wheel; and

a driving unit configured to drive the driving wheel, and

the path specifying unit:

generates a control signal for controlling the driving unit based on the control information; and

corrects, when the control information is to be corrected, the control signal according to the path for the mobile body to evade the hazardous area.

(Supplementary Notes 7)

A mobile body comprising:

a receiving unit configured to receive control information from a control unit; and

a path specifying unit configured to specify a path of the mobile body based on the control information, wherein

the path specifying unit corrects, according to a distance between the mobile body and an obstacle, the path of the mobile body to such a path that the mobile body evades a hazardous area including an area around the obstacle.

(Supplementary Note 8)

The mobile body described in Supplementary note 7, wherein the path specifying unit corrects the path of the mobile body when the distance between the mobile body and the obstacle becomes shorter than a first distance for the mobile body to evade the hazardous area.

(Supplementary Note 9)

The mobile body described in Supplementary note 8, wherein the path specifying unit specifies the first distance and the hazardous area according to a type of the obstacle.

(Supplementary Note 10)

The mobile body described in Supplementary note 8, wherein the path specifying unit specifies the first distance and the hazardous area according to a speed of the mobile body indicated by the control information.

(Supplementary Note 11)

The mobile body described in Supplementary note 7 or 8, wherein the path specifying unit specifies the hazardous area according to a movement of the mobile body indicated by the control information.

(Supplementary Note 12)

The mobile body described in any one of Supplementary notes 8 to 11, further comprising:

a driving wheel; and

a driving unit configured to drive the driving wheel, wherein

the path specifying unit:

generates a control signal for controlling the driving unit based on the control information; and

corrects, when the control information is to be corrected, the control signal according to the path for the mobile body to evade the hazardous area.

(Supplementary Note 13)

A method for controlling a mobile body, comprising:

a receiving step of receiving control information from a control unit; and

a path specifying step of specifying a path of the mobile body based on the control information, wherein

in the path specifying step, the path of the mobile body is corrected, according to a distance between the mobile body and an obstacle, to such a path that the mobile body evades a hazardous area including an area around the obstacle corrects.

(Supplementary Note 14)

The method for controlling a mobile body described in Supplementary note 13, wherein in the path specifying step, the path of the mobile body is corrected when the distance between the mobile body and the obstacle becomes shorter than a first distance for the mobile body to evade the hazardous area.

(Supplementary Note 15)

The method for controlling a mobile body described in Supplementary note 14, wherein in the path specifying step, the first distance and the hazardous area are specified according to a type of the obstacle.

(Supplementary Note 16)

The method for controlling a mobile body described in Supplementary note 14, wherein in the path specifying step, the first distance and the hazardous area are specified according to a speed of the mobile body indicated by the control information.

(Supplementary Note 17)

The method for controlling a mobile body described in Supplementary note 13 or 14, wherein in the path specifying step, the hazardous area is specified according to a movement of the mobile body indicated by the control information.

(Supplementary Note 18)

The method for controlling a mobile body described in any one of Supplementary notes 14 to 17, wherein the mobile body comprises:

a driving wheel; and

a driving unit configured to drive the driving wheel, and

in the path specifying step,

a control signal for controlling the driving unit is generated based on the control information, and

when the control information is to be corrected, the control signal is corrected according to the path for the mobile body to evade the hazardous area.

### REFERENCE SIGNS LIST

1, 1A, 2 MOBILE BODY CONTROL SYSTEMS
10 MOBILE BODY
11L, 11R DRIVING WHEEL
20 CONTROL UNIT
30 RECEIVING UNIT
40 PATH SPECIFYING UNIT
41 DISTANCE MEASUREMENT UNIT
42 CORRECTION NECESSITY DETERMINATION UNIT
43 OFFSET VALUE CALCULATION UNIT
44 CONTROL SIGNAL GENERATION UNIT
50 DRIVING UNIT
90 COMPUTER
91 PROCESSOR
92 MEMORY
93 STORAGE
94 INPUT/OUTPUT INTERFACE
941 DISPLAY DEVICE
942 INPUT DEVICE
943 SOUND OUTPUT DEVICE
95 COMMUNICATION INTERFACE
D1 FIRST DISTANCE
D2 SECOND DISTANCE
D3 THIRD DISTANCE

What is claimed is:

1. A mobile body control system comprising:
a mobile body; and
a controller configured to control the mobile body, wherein
the mobile body comprises:
at least one memory storing instructions, and
at least one processor configured to execute the instructions to;
receive control information from the controller;
specify a path of the mobile body based on the control information, and
correct, according to a distance between the mobile body and an obstacle, the path of the mobile body to such a path that the mobile body evades a hazardous area including an area around the obstacle.

2. The mobile body control system according to claim 1, wherein the at least one processor is further configured to execute the instructions to corrects the path of the mobile body when the distance between the mobile body and the obstacle becomes shorter than a first distance for the mobile body to evade the hazardous area.

3. The mobile body control system according to claim 2, wherein the at least one processor is further configured to execute the instructions to specify the first distance and the hazardous area according to a type of the obstacle.

4. The mobile body control system according to claim 2, wherein the at least one processor is further configured to execute the instructions to specify the first distance and the hazardous area according to a speed of the mobile body indicated by the control information.

5. The mobile body control system according to claim 1, wherein the at least one processor is further configured to execute the instructions to specify the hazardous area according to a movement of the mobile body indicated by the control information.

6. The mobile body control system according to claim 2, wherein
the mobile body comprises:
a driving wheel; and
a driving unit configured to drive the driving wheel, and
the at least one processor is further configured to execute the instructions to:
generates a control signal for controlling the driving unit based on the control information; and
correct, when the control information is to be corrected, the control signal according to the path for the mobile body to evade the hazardous area.

7. A mobile body comprising:
at least one memory storing instructions, and
at least one processor configured to execute the instructions to;
receive control information from a controller;
specify a path of the mobile body based on the control information, and
correct, according to a distance between the mobile body and an obstacle, the path of the mobile body to such a path that the mobile body evades a hazardous area including an area around the obstacle.

8. The mobile body according to claim 7, wherein the at least one processor is further configured to execute the instructions to corrects the path of the mobile body when the distance between the mobile body and the obstacle becomes shorter than a first distance for the mobile body to evade the hazardous area.

9. The mobile body according to claim 8, wherein specifies the at least one processor is further configured to execute the instructions to specify the first distance and the hazardous area according to a type of the obstacle.

10. The mobile body according to claim 8, wherein specifics the at least one processor is further configured to execute the instructions to specify the first distance and the hazardous area according to a speed of the mobile body indicated by the control information.

11. The mobile body according to claim 7, wherein the at least one processor is further configured to execute the instructions to specify the hazardous area according to a movement of the mobile body indicated by the control information.

12. The mobile body according to claim 8, further comprising:
a driving wheel; and
a driving unit configured to drive the driving wheel, wherein
the at least one processor is further configured to execute the instructions to:
generates a control signal for controlling the driving unit based on the control information; and
correct, when the control information is to be corrected, the control signal according to the path for the mobile body to evade the hazardous area.

13. A method for controlling a mobile body, comprising:
a receiving step of receiving control information from a controller; and
a path specifying step of specifying a path of the mobile body based on the control information, wherein
in the path specifying step, the path of the mobile body is corrected, according to a distance between the mobile body and an obstacle, to such a path that the mobile body evades a hazardous area including an area around the obstacle corrects.

14. The method for controlling a mobile body according to claim 13, wherein in the path specifying step, the path of the mobile body is corrected when the distance between the mobile body and the obstacle becomes shorter than a first distance for the mobile body to evade the hazardous area.

15. The method for controlling a mobile body according to claim 14, wherein in the path specifying step, the first distance and the hazardous area are specified according to a type of the obstacle.

16. The method for controlling a mobile body according to claim 14, wherein in the path specifying step, the first distance and the hazardous area are specified according to a speed of the mobile body indicated by the control information.

17. The method for controlling a mobile body according to claim 13, wherein in the path specifying step, the hazardous area is specified according to a movement of the mobile body indicated by the control information.

18. The method for controlling a mobile body according to claim 14, wherein
the mobile body comprises:
a driving wheel; and
a driving unit configured to drive the driving wheel, and
in the path specifying step,
a control signal for controlling the driving unit is generated based on the control information, and
when the control information is to be corrected, the control signal is corrected according to the path for the mobile body to evade the hazardous area.
